(19) United States
(12) Patent Application Publication
(10) Pub. No.: US 2024/0070842 A1
(43) Pub. Date: Feb. 29, 2024

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: YUMA WATANABE, Kanagawa (JP)

(21) Appl. No.: 18/452,254

(22) Filed: Aug. 18, 2023

(30) Foreign Application Priority Data
Aug. 23, 2022 (JP) 2022-132586

(51) Int. Cl. G06T 7/00; G06T 7/13; G06T 7/40; G06T 7/73

(52) U.S. Cl. CPC G06T 7/0004; G06T 7/13; G06T 7/40; G06T 7/73

(57) ABSTRACT

An image processing apparatus includes an acquisition unit configured to acquire image data obtained by imaging an object having a surface on which an illumination image is generated, a calculation unit configured to calculate a variation amount of an edge position of the illumination image and a variation amount of an edge luminance of the illumination image based on the image data, and an evaluation unit configured to evaluate a state of the surface of the object based on the variation amount of the edge position and the variation amount of the edge luminance.

### BACKGROUND OF THE DISCLOSURE

### Field of the Disclosure

The present disclosure relates to an image processing technique for evaluating a state of a surface of an object.

### Description of the Related Art

In a case where a surface of an industrial product is to be smoothed by coating, a coating material can harden before the surface is smoothed, depending on a condition for coating. In a case where the coating material hardens unintentionally, minute irregularities called orange peel can occur, which can cause deterioration in designability. Japanese Patent Application Laid-Open No. 2019-211457 discusses a technique in which a degree of jaggedness of a shadow formed on an object by blocking light from a light source is evaluated as a degree of orange peel.

In Japanese Patent Application Laid-Open No. 2019-211457, however, there is a case where the correlation between an evaluation result and a subjective evaluation by visual observation is low.

### SUMMARY OF THE DISCLOSURE

The present disclosure is directed to providing processing for obtaining an evaluation result correlated with a subjective evaluation made by visual observation in a case where a state of a surface of an object is evaluated.

According to an aspect of the present disclosure, an image processing apparatus includes an acquisition unit configured to acquire image data obtained by imaging an object having a surface on which an illumination image is generated, a calculation unit configured to calculate a variation amount of an edge position of the illumination image and a variation amount of an edge luminance of the illumination image based on the image data, and an evaluation unit configured to evaluate a state of the surface of the object based on the variation amount of the edge position and the variation amount of the edge luminance.

Further features of the present disclosure will become apparent from the following description of exemplary embodiments with reference to the attached drawings.

### BRIEF DESCRIPTION OF THE DRAWINGS

FIG. 1 is a diagram illustrating an appearance of an evaluation system.

FIGS. 2A, 2B, and 2C are diagrams illustrating orange peel evaluation.

FIG. 3 is a diagram illustrating a functional configuration of an image processing apparatus.

FIGS. 4A and 4B are flowcharts each illustrating processing executed by the image processing apparatus.

FIG. 5 is a flowchart illustrating processing executed by the image processing apparatus.

FIG. 6 is a diagram illustrating an example of a user interface.

FIG. 7 is a diagram illustrating a hardware configuration of the image processing apparatus.

FIG. 8 is a diagram illustrating orange peel evaluation.

FIG. 9 is a diagram illustrating a functional configuration of the image processing apparatus.

### DESCRIPTION OF THE EMBODIMENTS

Exemplary embodiments will be described with reference to the drawings. The present disclosure is not necessarily limited to the following exemplary embodiments. Not all of combinations of features described in each of the exemplary embodiments are necessarily required for a solution of the present disclosure.

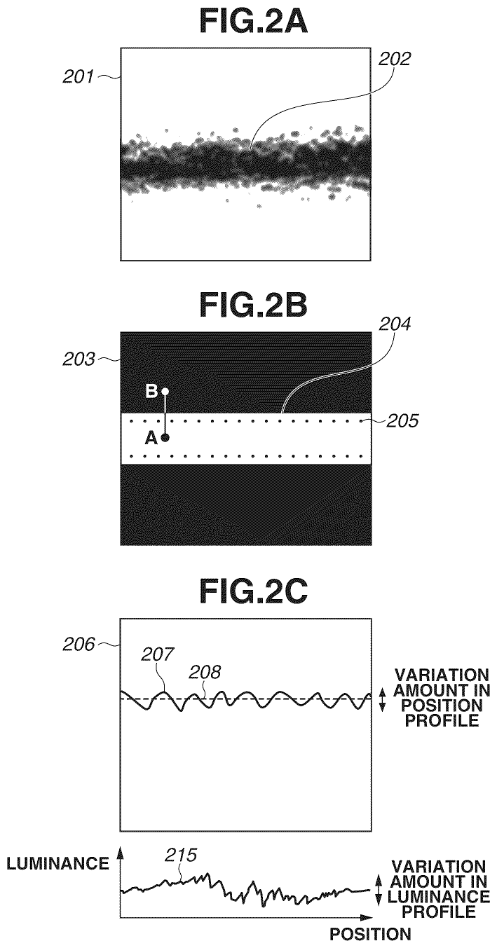

A first exemplary embodiment will be described. FIGS. 2A, 2B, and 2C are diagrams illustrating orange peel evaluation. FIG. 2A is a diagram illustrating an example of a captured image 201 obtained by imaging an object having a surface on which a line-shaped illumination image 202 is generated, by being irradiated with light by an illumination apparatus. The captured image 201 includes an area corresponding to the illumination image 202. In a case where there are minute irregularities called orange peel on an inspection surface of the object, variations in luminance near an edge of the illumination image 202 are visually recognized. FIG. 2B is a diagram illustrating an example of a captured image 203 schematically representing the captured image 201. Luminance variations 205 schematically indicate luminance variations near an edge of an illumination image 204 in the captured image 203. The luminance variations 205 are also visually recognized as jaggedness of the edge.

FIG. 2C is a diagram illustrating a position profile and a luminance profile near the edge of the illumination image 204. An area 206 indicates an area corresponding to the captured image 203. A position profile 207 is a position profile indicating an edge position of the illumination image 204 in a vertical direction, and is generated by known edge-detection processing. An approximate line 208 is the approximate line of the position profile 207. As a method of evaluating the degree of orange peel on the surface of the object, there is a method that uses a variation amount of an edge position with respect to the approximate line 208, i.e., a variation amount (standard deviation) in the position profile 207, as an orange peel evaluation value.

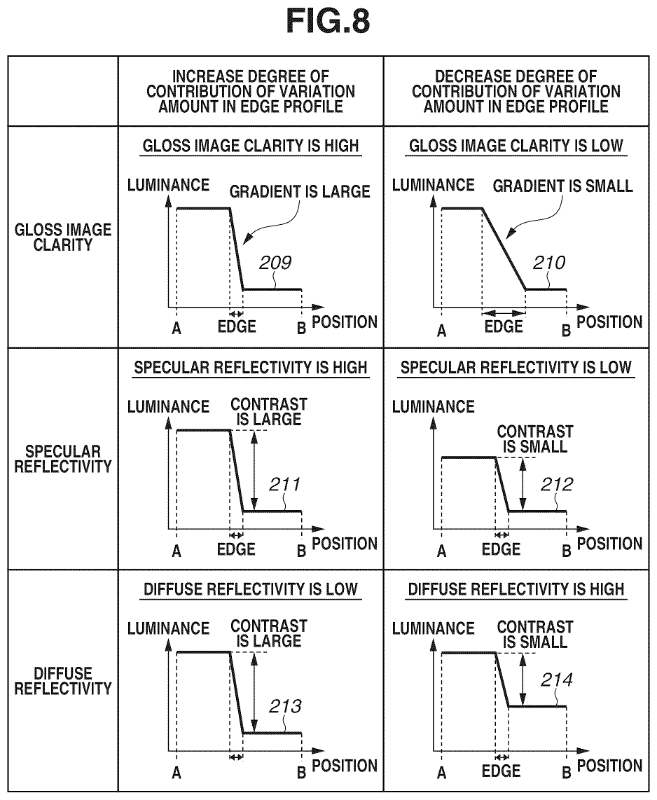

However, there is a case where the variation amount in the position profile 207 has a low correlation with a subjective evaluation value obtained by subjective evaluation experiment performed on a plurality of coated surfaces that vary in a coated state. The cause of the low correlation with the evaluation value will be described with reference to FIG. 8. FIG. 8 is a diagram illustrating a luminance distribution (a distribution of pixel values) from a point A to a point B in the captured image 203 in FIG. 2B. A luminance distribution 209 indicates a luminance distribution in a case where an inspection surface with high gloss image clarity is imaged. A luminance distribution 210 indicates a luminance distribution in a case where an inspection surface with low gloss image clarity is imaged. In a case where the luminance distribution 209 and the luminance distribution 210 are compared with each other, it is found that the gradient of an edge in the case of the low gloss image clarity is less than that in the case of the high gloss image clarity. Because the gradient of the edge is small, it is less likely that the luminance variations 205 in FIG. 2B are visually recognized as the jaggedness of the edge. For this reason, in a case where the method using the variation amount in the position profile as the orange peel evaluation value is used, there is a case where the orange peel evaluation value pertaining to an evaluation sample with low gloss image clarity is abnormally greater than the subjective evaluation value. The gloss image clarity is defined in JIS K 7374.

A luminance distribution 211 indicates a luminance distribution in a case where a surface with high specular reflectivity is imaged.

A luminance distribution 212 indicates a luminance distribution in a case where a surface with low specular reflectivity is imaged. In a case where the luminance distribution 211 and the luminance distribution 212 are compared with each other, it is found that, in the case of the low specular reflectivity, an amount of light reflected from the illumination image 204 is smaller and thus contrast between an edge and a background area is smaller, than that in the case of the high specular reflectivity. Because the contrast between the edge and the background area is small, it is less likely that the luminance variations 205 in FIG. 2B are visually recognized as the jaggedness of the edge. For this reason, in the method using the variation amount in the position profile as the orange peel evaluation value, there is a case where the orange peel evaluation value pertaining to an evaluation sample with low specular reflectivity is abnormally greater than the subjective evaluation value. The specular reflectivity is defined in JIS Z 8741.

A luminance distribution 213 indicates a luminance distribution in a case where an inspection surface with low diffuse reflectivity is imaged.

A luminance distribution 214 indicates a luminance distribution in a case where an inspection surface with high diffuse reflectivity is imaged. In a case where the luminance distribution 213 and the luminance distribution 214 are compared with each other, it is found that, in the case of the high diffuse reflectivity, an amount of light reflected from a background area of the illumination image 204 is larger and thus contrast between an edge and the background area is smaller, than that in the case of the low diffuse reflectivity. Because the contrast between the edge and the background area is small, it is less likely that the luminance variations 205 in FIG. 2B are visually recognized as the jaggedness of the edge. For this reason, in the method using the variation amount in the position profile as the orange peel evaluation value, there is a case where the orange peel evaluation value pertaining to an evaluation sample with high diffuse reflectivity is abnormally greater than the subjective evaluation value. The diffuse reflectivity is defined in JIS Z 8105.

According to the subjective evaluation experiment, it has been found that the larger the width of the illumination image 204 is, the less likely it is to visually recognize the jaggedness of the edge. This is because, conceivably, the larger the width of the illumination image 204 is, the smaller the ratio of the jaggedness width of the edge to the width of the illumination image 204 is. In the method using the variation amount in the position profile as the orange peel evaluation value, there is a case where the orange peel evaluation value is abnormally greater than the subjective evaluation value, also under the condition that the width of the illumination image 204 is large.

In the present exemplary embodiment, in a case where an inspection surface with low gloss image clarity, an inspection surface with low specular reflectivity, or an inspection surface with high diffuse reflectivity is inspected, or under the condition that the width of the illumination image 204 is large, the contribution of the variation amount in the position profile to the orange peel evaluation value is reduced. Here, assume that the gloss image clarity of the inspection surface is C, the specular reflectivity of the inspection surface is rₛ, the diffuse reflectivity of the inspection surface is r_{d}, and the width of the illumination image 204 in the captured image 203 is W. Further, assume that the variation amount in the position profile 207 in FIG. 2C is σₚ. An orange peel evaluation value E is derived by the following equation (1).

E=(C)^{α}(rₛ)_{β}(r_{d})^{-γ}(W)^{-δ}σₚ (1)

In the equation (1), α, β, γ, and δ are real numbers larger than 0, and are set by known optimization processing so that the correlation between the subjective evaluation value and the orange peel evaluation value E is maximized. C, rₛ, r_{d}, W, and σₚ are each multiplied by a proportionality coefficient for scaling, and the proportionality coefficient for multiplying each of these values is also set by known optimization processing.

An orange peel evaluation value in Japanese Patent Application Laid-Open No. 2019-211457 corresponds to a case where α, β, γ, and δ are 0 in the equation (1), and thus is E=σₚ. On the other hand, in the orange peel evaluation value in the present exemplary embodiment, α, β, γ, and δ are real numbers larger than 0 in the equation (1). For this reason, (C)^{α}(rₛ)^{β} is small in the equation (1) on the inspection surface where the gloss image clarity C is low or the inspection surface where the specular reflectivity rₛ is low, and thus the contribution of the variation amount σₚ in the position profile 207 is reduced. Similarly, (r_{d})^{-γ}(W)^{-δ} is small in the equation (1) on the inspection surface where the diffuse reflectivity r_{d} is high or under the condition that the width W of the illumination image 204 is large, and thus the contribution of the variation amount σₚ in the position profile 207 is reduced.

In a case where the equation (1) is used, the gloss image clarity C, the specular reflectivity rₛ, and the diffuse reflectivity r_{d} can be acquired using a known measuring instrument. The distance between the upper and lower edge positions is used as the width W of the illumination image 204. The upper and lower edge positions can be derived by known edge-detection processing.

The gradient of the edge illustrated in FIG. 8 may be used in place of the gloss image clarity C. The gloss image clarity is considered higher, as the gradient of the edge acquired based on the captured image 203 is larger. The contrast of the edge illustrated in FIG. 8 may be used in place of the specular reflectivity rₛ and the diffuse reflectivity r_{d}. The specular reflectivity is considered higher and the diffuse reflectivity is considered lower, as the contrast of the edge acquired based on the captured image 203 is larger. In a case where the gradient of the edge is G and the contrast of the edge is R, the orange peel evaluation value E is derived by the following equation (2).

E=(G)^{α}(R)^{β}(W)^{-γ}σₚ (2)

In the equation (2), α, β, and γ are real numbers larger than 0, and are set by optimization processing as with the equation (1). According to the equation (2), on the inspection surface where the edge gradient G is small, and the inspection surface where the edge contrast R is small, (G)^{α}(R)^{β} is small in the equation (2), and thus the contribution of the variation amount σₚ in the position profile 207 is reduced.

As described above, according to the orange peel evaluation value of the equation (1) or the equation (2), the correlation with the subjective evaluation value improves in comparison with the conventional orange peel evaluation value. Further, not only the jaggedness of the edge but also the luminance variation are visually recognized when the subjective evaluation of the orange peel is performed. In particular, in the equation (1) or the equation (2), in a case where the contribution of the variation amount σₚ in the position profile 207 is small, an evaluator of the subjective evaluation experiment focuses more attention on the luminance variation than on the jaggedness of the edge. For this reason, the correlation between the orange peel evaluation value and the subjective evaluation value is further improved by adding the influence of the luminance variation to the equation (1) and the equation (2). In this case, at first, pixel values of the captured image 203 in FIG. 2B are acquired along the approximate line 208 in FIG. 2C, and a luminance profile 215 is generated. The variation amount (standard deviation) in the luminance profile 215 is added to the equation (1) and the equation (2), as a luminance variation σᵢ. The equation (1) and the equation (2) are thereby changed to an equation (3) and an equation (4), respectively.

E=(C)^{α}(rₛ)¹³(r_{d})^{-γ}(W)^{-δ}αₚ+kσᵢ (3)

E=(G)^{α}(R)^{β}(W)^{-γ}σₚ+kσᵢ (4)

k is a proportional constant. The orange peel evaluation value E of each of the equation (3) and the equation (4) is the weighted sum of the variation amount σₚ in the position profile and the variation amount σᵢ in the luminance profile. In the equation (3), (C)^{α}(rₛ)^{β}(r_{d})−γ(W)^{-δ} is the weight of the variation amount σₚ, and k is the weight of the variation amount σᵢ. In the equation (4), (G)^{α}(R)^{β}(W)^{-γ} is the weight of the variation amount σₚ, and k is the weight of the variation amount αᵢ. The weight k of the variation amount σᵢ, is set by optimization processing together with other parameters such as α, β, and γ so that the correlation between the subjective evaluation value and the orange peel evaluation value E is maximized. According to the equation (3) or the equation (4) described above, the orange peel evaluation value having a high correlation with the subjective evaluation value can be obtained. The method of deriving the orange peel evaluation value will be described in detail.

### <Evaluation System>

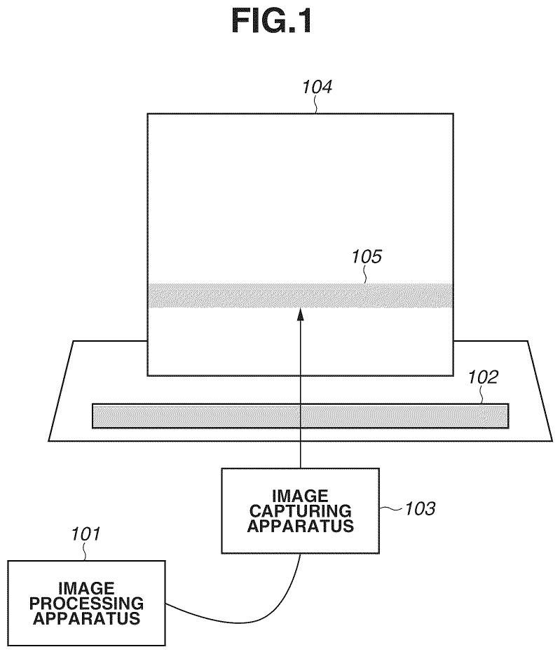

FIG. 1 is a diagram illustrating an appearance of an evaluation system in the present exemplary embodiment. The evaluation system includes an image processing apparatus 101, an illumination apparatus 102, and an image capturing apparatus 103. The illumination apparatus 102 is a fluorescent tube, and generates a line-shaped illumination image 105 on an object 104 that is an evaluation target, by irradiating a surface of the object 104. The image capturing apparatus 103 is a camera, and images an inspection surface of the object 104 having the surface on which the line-shaped illumination image 105 is generated. The object 104 is a part of an industrial product such as a home electric appliance, and an evaluation target surface is a coated surface having metallic luster. The image processing apparatus 101 is connected to the image capturing apparatus 103, and controls exposure, focus, and imaging timing of the image capturing apparatus 103. The image processing apparatus 101 evaluates the state of the surface of the object 104, based on captured image data acquired by imaging. Specifically, the image processing apparatus 101 calculates the orange peel evaluation value corresponding to the inspection surface of the object 104 and displays the calculated orange peel evaluation value to a user.

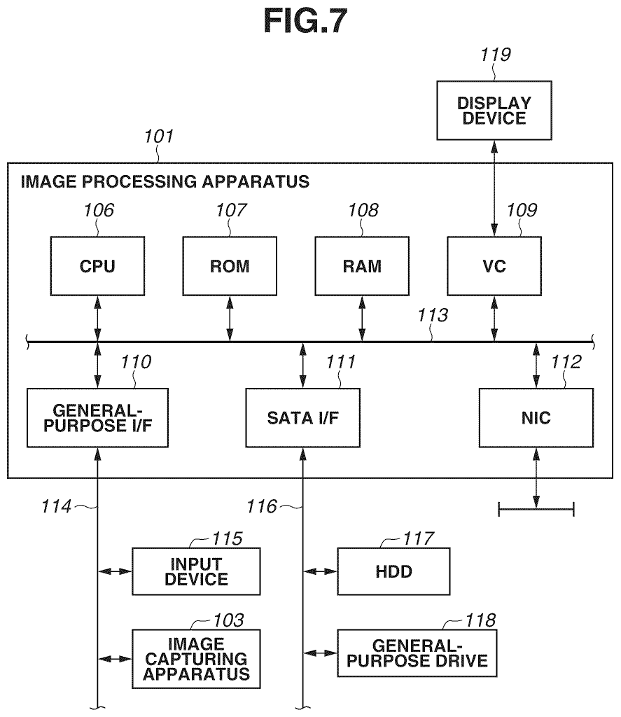

FIG. 7 is a block diagram illustrating a hardware configuration of the image processing apparatus 101. The image processing apparatus 101 includes a central processing unit (CPU) 106, a read only memory (ROM) 107, and a random access memory (RAM) 108. The image processing apparatus 101 further includes a video card (VC) 109, a general-purpose interface (UF) 110, a serial advanced technology attachment (SATA) I/F 111, and a network interface card (NIC) 112. The CPU 106 executes an operating system (OS) and various programs stored in the ROM 107, a hard disk drive (HDD) 117, and the like, by using the RAM 108 as a work memory. The CPU 106 controls each component via a system bus 113. The CPU 106 executes processing based on a flowchart to be described below, by loading a program code stored in the ROM 107, the HDD 117, or the like into the RAM 108 and executing the program code. A display device 119 is connected to the VC 109. An input device 115 including a mouse and a keyboard and the image capturing apparatus 103 are connected to the general-purpose OF 110 via a serial bus 114. The HDD 117 and a general-purpose drive 118 that reads from and writes to various recording mediums are connected to the SATA OF 111 via a serial bus 116. The NIC 112 inputs and outputs information to and from an external apparatus. The CPU 106 uses various recording mediums mounted on the HDD 117 and the general-purpose drive 118 as storages for various data. The CPU 106 displays a user interface (UI) provided by a program on the display device 119, and receives an input such as a user instruction via the input device 115. The display device 119 may be a touch panel display having a touch panel function for detecting a touch position of a pointer such as a finger.

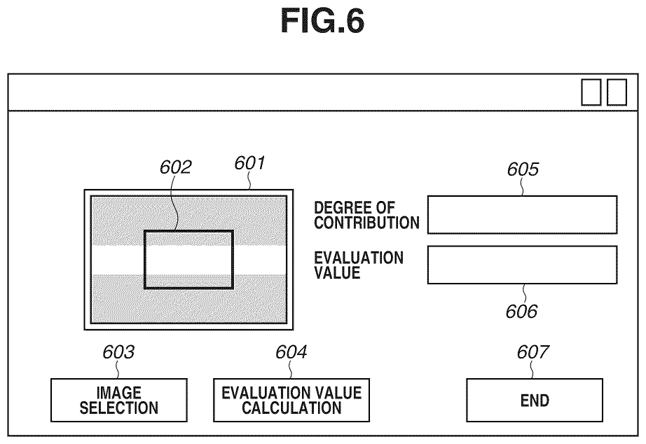

FIG. 6 is a diagram illustrating an example of the UI displayed on the display device 119. An image display window 601 is a window that displays an image represented by image data designated by the user. An evaluation range designation area 602 is an evaluation target area designated by a rectangle in the image. An image selection button 603 is a button for designating image data corresponding to an image that the user wants to display. An evaluation value calculation button 604 is a button for giving an instruction to start calculating the orange peel evaluation value for the designated area. The degree of contribution of the variation amount in the position profile to the orange peel evaluation value is displayed in a contribution degree display text box 605. The calculated orange peel evaluation value is displayed in an evaluation value display text box 606. An end button 607 is a button for giving an instruction to end the application.

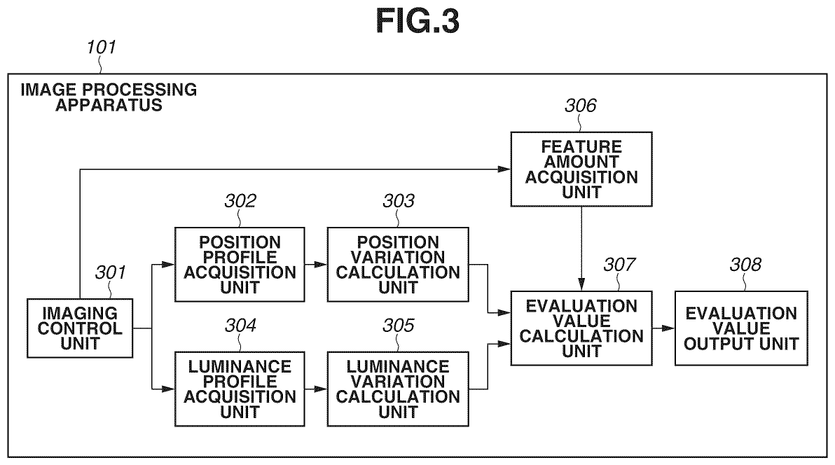

FIG. 3 is a block diagram illustrating a functional configuration of the image processing apparatus 101. The CPU 106 reads out a program stored in the ROM 107 or the HDD 117 and executes the program using the RAM 108 as a work memory, thereby functioning as the functional configuration illustrated in FIG. 3. It is not necessary for the CPU 106 to execute all of processing to be described below, and the image processing apparatus 101 may be configured so that a part or all of the processing is performed by one or more processing circuits other than the CPU 106.

The image processing apparatus 101 includes an imaging control unit 301, a position profile acquisition unit 302, a position variation calculation unit 303, a luminance profile acquisition unit 304, a luminance variation calculation unit 305, a feature amount acquisition unit 306, an evaluation value calculation unit 307, and an evaluation value output unit 308. The imaging control unit 301 controls the image capturing apparatus 103, thereby imaging an inspection surface of an object having a surface on which a line-shaped illumination image is generated, and acquiring captured image data. The position profile acquisition unit 302 acquires a position profile indicating the position of an edge of the illumination image based on the acquired captured image data. The position variation calculation unit 303 calculates the variation amount σₚ of the edge position in the acquired position profile. The luminance profile acquisition unit 304 acquires a luminance profile indicating a variation amount of luminance at the edge of the illumination image based on the acquired captured image data. The luminance variation calculation unit 305 calculates the variation amount σᵢ of the edge luminance in the acquired luminance profile. The feature amount acquisition unit 306 acquires the gloss image clarity C, the specular reflectivity rₛ, the diffuse reflectivity r_{d}, and the illumination image width W, for an evaluation target object. The evaluation value calculation unit 307 calculates the orange peel evaluation value E for evaluating the degree of orange peel on the surface of the object. The evaluation value output unit 308 outputs the calculated orange peel evaluation value E.

### <Processing Executed by Image Processing Apparatus>

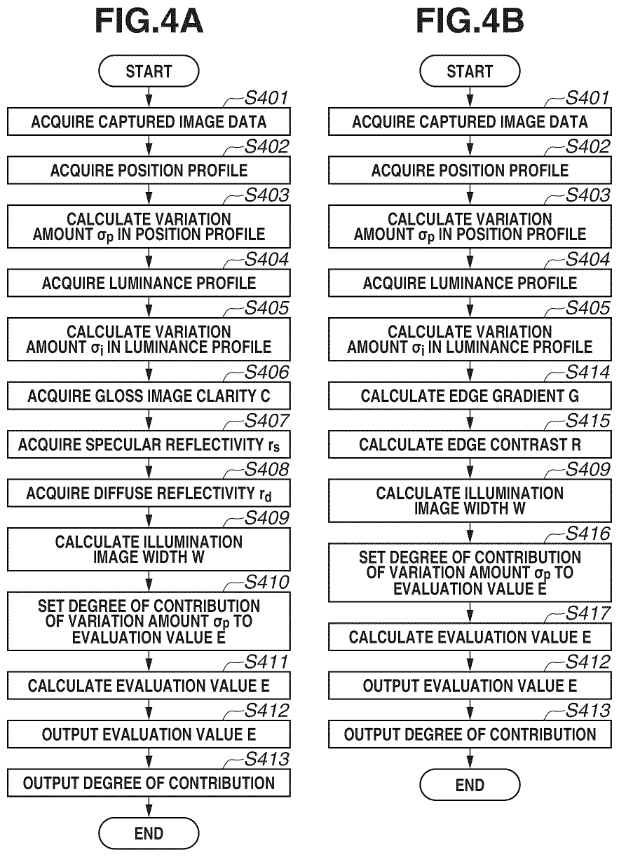

A series of processes of processing that the image processing apparatus 101 executes in the present exemplary embodiment will be described with reference to a flowchart in FIG. 4A. An instruction is input by the user via the input device 115, and the CPU 106 accepts the input instruction, thereby starting the processing indicated by the flowchart in FIG. 4A.

In step S401, the imaging control unit 301 controls the image capturing apparatus 103, thereby imaging an inspection surface of an object having a surface on which a line-shaped illumination image is generated, and acquiring captured image data. In step S402, the position profile acquisition unit 302 acquires a position profile indicating the position of an edge of the illumination image based on the acquired captured image data. In step S403, the position variation calculation unit 303 calculates the variation amount σₚ of the edge position in the acquired position profile.

In step S404, the luminance profile acquisition unit 304 acquires a luminance profile indicating a variation amount of luminance at the edge of the illumination image based on the acquired captured image data. In step S405, the luminance variation calculation unit 305 calculates the variation amount σᵢ of the edge luminance in the acquired luminance profile. In step S406, the feature amount acquisition unit 306 acquires the gloss image clarity C obtained by measuring the inspection surface of the object using a known measuring instrument. In step S407, the feature amount acquisition unit 306 acquires the specular reflectivity rₛ obtained by measuring the inspection surface of the object using a known measuring instrument. In step S408, the feature amount acquisition unit 306 acquires the diffuse reflectivity r_{d} obtained by measuring the inspection surface of the object using a known measuring instrument. In step S409, the feature amount acquisition unit 306 calculates the illumination image width W based on the acquired captured image data.

In step S410, the evaluation value calculation unit 307 sets the degree of contribution of the variation amount σₚ of the edge position to the orange peel evaluation value E, based on the gloss image clarity C, the specular reflectivity rₛ, the diffuse reflectivity r_{d}, and the illumination image width W. In the present exemplary embodiment, the equation (3) is used, and thus (C)^{α}(rₛ)^{β}(r_{d})^{-γ}(W)^{-δ} is set as the degree of contribution. In step S411, the evaluation value calculation unit 307 calculates the orange peel evaluation value E for the evaluation target object based on the variation amount σₚ of the edge position, the variation amount σᵢ of the edge luminance, and the degree of contribution to the orange peel evaluation value E.

In step S412, the evaluation value output unit 308 outputs the orange peel evaluation value E calculated in step S411. Specifically, the evaluation value output unit 308 displays the calculated orange peel evaluation value E in the evaluation value display text box 606. In step S413, the evaluation value output unit 308 outputs the degree of contribution calculated in step S410. Specifically, the evaluation value output unit 308 displays the calculated degree of contribution in the contribution degree display text box 605.

As described above, the image processing apparatus in the present exemplary embodiment acquires the captured image data obtained by imaging the object having the surface on which the illumination image is generated, and calculates the variation amount of the edge position and the variation amount of the edge luminance of the illumination image based on the captured image data. The evaluation value for evaluating the state of the surface of the object is calculated based on the calculated variation amount of the edge position and the calculated variation amount of the edge luminance. This makes it possible to obtain an evaluation result correlated with a subjective evaluation made by visual observation, in a case where a state of a surface of an object is evaluated.

### <Modifications >

The imaging control unit 301 in the above-described exemplary embodiment acquires the captured image data by controlling imaging, but may function as a captured image data acquisition unit that acquires captured image data obtained beforehand by imaging, from a storage device such as the ROM 107 or the HDD 117.

In the above-described exemplary embodiment, the process relating to the luminance profile in step S404 and step S405 is performed after the process relating to the position profile in step S402 and step S403 is performed, but the order of performing the processes is not limited to this order. For example, the process relating to the position profile may be performed after the process relating to the luminance profile is performed, or these processes may be performed in parallel.

In the above-described exemplary embodiment, the degree of contribution of the variation amount σₚ of the edge position to the orange peel evaluation value E is used as the degree of contribution, but the degree of contribution of the variation amount σᵢ of the edge luminance to the orange peel evaluation value E may be used. Both of these degrees of contribution may be calculated and displayed in the contribution degree display text box 605.

In the first exemplary embodiment, the orange peel evaluation value is calculated using the equation (3), whereas in a second exemplary embodiment, the orange peel evaluation value is calculated using the equation (4). The configuration of an evaluation system in the present exemplary embodiment is similar to the configuration in the first exemplary embodiment, and thus the description thereof will be omitted. In the present exemplary embodiment, differences from the first exemplary embodiment will be mainly described. Configurations similar to those in the first exemplary embodiment are denoted by the same reference numerals as those of the first exemplary embodiment and will be described.

### <Processing Executed by Image Processing Apparatus>

A series of processes of processing that an image processing apparatus 101 executes in the present exemplary embodiment will be described with reference to a flowchart in FIG. 4B. An instruction is input by a user via an input device 115, and a CPU 106 accepts the input instruction, thereby starting the processing indicated by the flowchart in FIG. 4B.

In step S414, a feature amount acquisition unit 306 calculates the edge gradient G based on the acquired captured image data. In step S415, the feature amount acquisition unit 306 calculates the edge contrast R based on the acquired captured image data. In step S416, an evaluation value calculation unit 307 sets the degree of contribution of the variation amount σₚ of the edge position to the orange peel evaluation value E based on the illumination image width W, the edge gradient G, and the edge contrast R. In the present exemplary embodiment, the equation (4) is used, and thus (G)^{α}(R)^{β}(W)^{-γ} is set as the degree of contribution. In step S417, the evaluation value calculation unit 307 calculates the orange peel evaluation value E for the evaluation target object based on the variation amount σₚ of the edge position, the variation amount σᵢ of the edge luminance, and the degree of contribution to the orange peel evaluation value E.

As described above, the image processing apparatus in the present exemplary embodiment calculates the orange peel evaluation value, using the different method of setting the degree of contribution from the method in the first exemplary embodiment. This makes it possible to obtain an evaluation result correlated with a subjective evaluation made by visual observation, in a case where a state of a surface of an object is evaluated.

In the second exemplary embodiment, the orange peel evaluation value is calculated using the equation (4). In a third exemplary embodiment, the method of calculating the orange peel evaluation value is changed depending on the edge gradient G, the edge contrast R, the illumination image width W, and the like. This makes it possible to omit either the calculation of the variation amount σₚ in the position profile or the calculation of the variation amount σᵢ in the luminance profile, and thus the orange peel evaluation value can be calculated in a calculation amount less than that in the second exemplary embodiment.

Specifically, in a case where the edge gradient G is greater than a threshold Th₁, the edge contrast R is greater than a threshold Th₂, and the illumination image width W is less than a threshold Th₃, the orange peel evaluation value E of the equation (2) is calculated based on the variation amount σₚ in the position profile. Otherwise, kσᵢ that is the second term on the right of the equation (4) is calculated as the orange peel evaluation value E based on the variation amount σᵢ in the luminance profile. A predetermined value is set as each of the threshold Th₁, the threshold Th₂, and the threshold Th₃.

In a configuration of an evaluation system in the present exemplary embodiment, a functional configuration of an image processing apparatus 101 is different from the functional configuration in the first exemplary embodiment. In the present exemplary embodiment, differences from the above-described exemplary embodiments will be mainly described. Configurations similar to those in the above-described exemplary embodiments are denoted by the same reference numerals as those of the above-described exemplary embodiments and will be described.

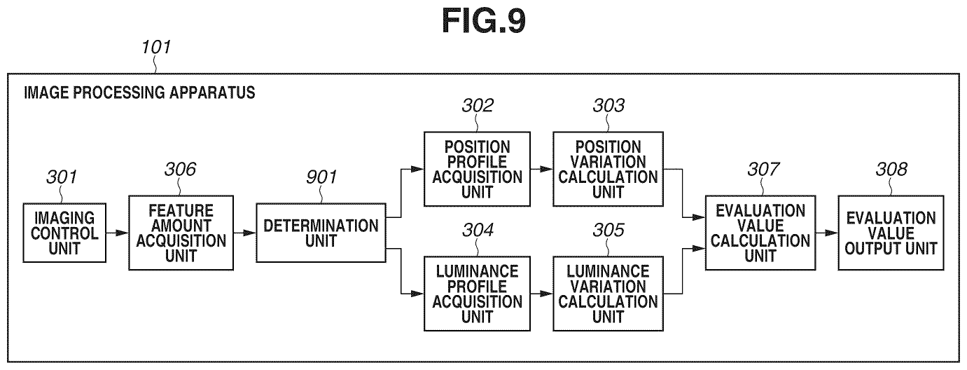

FIG. 9 is a block diagram illustrating the functional configuration of the image processing apparatus 101. A CPU 106 reads out and executes a program stored in a ROM 107 or an HDD 117 using a RAM 108 as a work memory, thereby functioning as the functional configuration illustrated in FIG. 9. It is not necessary for the CPU 106 to execute all of processing to be described below, and the image processing apparatus 101 may be configured so that a part or all of the processing is performed by one or more processing circuits other than the CPU 106.

The image processing apparatus 101 includes an imaging control unit 301, a position profile acquisition unit 302, a position variation calculation unit 303, a luminance profile acquisition unit 304, a luminance variation calculation unit 305, a feature amount acquisition unit 306, an evaluation value calculation unit 307, an evaluation value output unit 308, and a determination unit 901. The determination unit 901 determines which one of the variation amount σₚ in the position profile and the variation amount σᵢ in the luminance profile is to be used for the calculation of the orange peel evaluation value E based on the edge gradient G, the edge contrast R, and the illumination image width W.

### <Processing Executed by Image Processing Apparatus>

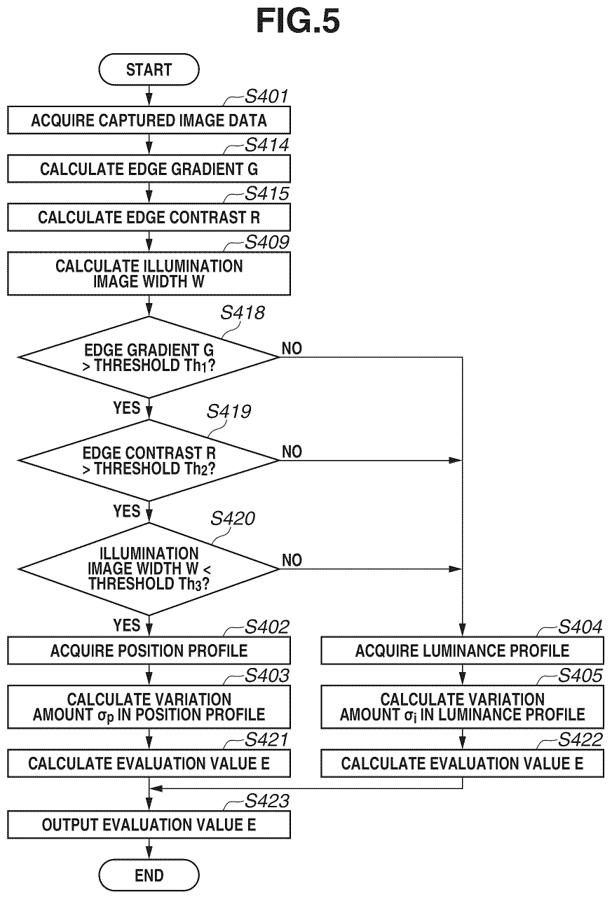

A series of processes of processing that the image processing apparatus 101 executes in the present exemplary embodiment will be described with reference to a flowchart in FIG. 5. An instruction is input by a user via an input device 115, and the CPU 106 accepts the input instruction, thereby starting the processing indicated by the flowchart in FIG. 5.

In step S418, the determination unit 901 determines whether the edge gradient G is greater than the threshold Th₁. In a case where the edge gradient G is greater than the threshold Th₁ (YES in step S418), the processing proceeds to step S419, and otherwise (NO in step S418), the processing proceeds to step S404. In step S419, the determination unit 901 determines whether the edge contrast R is greater than the threshold Th₂. In a case where the edge contrast R is greater than the threshold Th₂ (YES in step S419), the processing proceeds to step S420, and otherwise (NO in step S419), the processing proceeds to step S404. In step S420, the determination unit 901 determines whether the illumination image width W is less than the threshold Th 3. In a case where the illumination image width W is less than the threshold Th 3 (YES in step S420), the processing proceeds to step S402, and otherwise (NO in step S420), the processing proceeds to step S404.

In step S421, the evaluation value calculation unit 307 calculates the orange peel evaluation value E for the evaluation target object, using the equation (2), based on the variation amount σₚ of the edge position. In step S422, the evaluation value calculation unit 307 calculates kσᵢ that is the second term on the right of the equation (4) as the orange peel evaluation value E based on the variation amount σᵢ of the edge luminance. In step S423, the evaluation value output unit 308 outputs the orange peel evaluation value E calculated in step S421 or step S422.

As described above, the image processing apparatus in the present exemplary embodiment changes the method of calculating the orange peel evaluation value based on the feature amount relating to the illumination image. This makes it possible to obtain an evaluation result correlated with a subjective evaluation made by visual observation, in a calculation amount less than that in the above-described exemplary embodiments.

In the above-described exemplary embodiments, the case where the equation (3) is used and the case where the equation (4) is used are separately described, but the orange peel evaluation value E may be calculated by the equation (3) and the equation (4) in combination.

For example, the degree of contribution of the variation amount σₚ of the edge position to the orange peel evaluation value E may be calculated as (C)^{α}(R)^{β}(W)^{-γ}, by using the gloss image clarity C in the equation (4), in place of the edge gradient G.

In the above-described exemplary embodiments, the variation amount in the luminance profile 215 is used as the variation amount σᵢ of the edge luminance, but a variation amount of luminance in a predetermined area near the edge may be used. For example, a variation amount (standard deviation) of luminance in an area having a predetermined width along the approximate line 208 may be used.

In a case where evaluation targets and evaluation conditions are limited, and the degree of contribution of the variation amount σₚ of the edge position to the orange peel evaluation value E is always small, the degree of contribution of the variation amount σₚ of the edge position to the orange peel evaluation value E may be a constant. For example, kₚσₚ+kᵢσᵢ may be output as the orange peel evaluation value E. Alternatively, either kₚσₚ or kᵢσᵢ may be output as the orange peel evaluation value E, whichever is greater in value. Here, kₚ and kᵢ are set by optimization processing so that the correlation with the subjective evaluation value is maximized.

kₚ and kᵢ may be optimized for each shape of evaluation target object or each geometry condition in imaging, and it is acceptable to switch between kₚ and kᵢ at the time of evaluation. For example, it is acceptable to switch between kₚ and kᵢ depending on the curvature of the inspection surface, and it is also acceptable to switch between kₚ and kᵢ depending on the distance between the image capturing apparatus 103 and the inspection surface, or the incident angle of light emitted from the illumination apparatus 102. For example, in a case where the inspection surface is a convex surface or a concave surface, the value of the variation amount σₚ of the edge position can be abnormally large because of a complicated curve of the edge. Therefore, kₚ may be reduced in a case where the curvature of the approximate line 208 is greater than a predetermined value.

It is possible to detect a defective article to be consistent with the subjectivity of a person, by using the orange peel evaluation value E output by any of the above-described exemplary embodiments, for detection of a defective article. For example, the orange peel evaluation value E may be compared with a predetermined threshold, and occurrence of a defective article may be notified in a case where the orange peel evaluation value E is greater than the predetermined threshold.

According to the exemplary embodiments of the present disclosure, it is possible to obtain an evaluation result correlated with a subjective evaluation made by visual observation, in a case where a state of a surface of an object is evaluated.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-132586, filed Aug. 23, 2022, which is hereby incorporated by reference herein in its entirety.

What is claimed is:

1. An image processing apparatus comprising:
an acquisition unit configured to acquire image data obtained by imaging an object having a surface on which an illumination image is generated;
a calculation unit configured to calculate a variation amount of an edge position of the illumination image and a variation amount of an edge luminance of the illumination image based on the image data; and
an evaluation unit configured to evaluate a state of the surface of the object based on the variation amount of the edge position and the variation amount of the edge luminance.

2. The image processing apparatus according to claim 1, wherein the calculation unit calculates the variation amount of the edge position and the variation amount of the edge luminance based on a first profile indicating the edge position of the illumination image and a second profile indicating the edge luminance of the illumination image.

3. The image processing apparatus according to claim 1, wherein the evaluation unit calculates a weighted sum of the variation amount of the edge position and the variation amount of the edge luminance, as an evaluation value.

4. The image processing apparatus according to claim 1, wherein the evaluation unit makes a degree of contribution of the variation amount of the edge position to an evaluation value smaller as gloss image clarity of the object is lower.

5. The image processing apparatus according to claim 1, wherein the evaluation unit makes a degree of contribution of the variation amount of the edge position to an evaluation value smaller as a specular reflectivity of the object is lower.

6. The image processing apparatus according to claim 1, wherein the evaluation unit makes a degree of contribution of the variation amount of the edge position to an evaluation value smaller as a diffuse reflectivity of the object is higher.

7. The image processing apparatus according to claim 1, wherein the evaluation unit makes a degree of contribution of the variation amount of the edge position to an evaluation value smaller as a gradient of the edge is smaller.

8. The image processing apparatus according to claim 1, wherein the evaluation unit makes a degree of contribution of the variation amount of the edge position to an evaluation value smaller as a contrast of the edge is smaller.

9. The image processing apparatus according to claim 1, wherein the evaluation unit makes a degree of contribution of the variation amount of the edge position to an evaluation value smaller as a width of the illumination image is larger.

10. An image processing method comprising:
acquiring image data obtained by imaging an object having a surface on which an illumination image is generated;
calculating a variation amount of an edge position of the illumination image and a variation amount of an edge luminance of the illumination image based on the image data; and
evaluating a state of the surface of the object based on the variation amount of the edge position and the variation amount of the edge luminance.

11. A non-transitory computer-readable storage medium storing instructions that, when executed by a computer, cause the computer to perform an image processing method, the image processing method comprising:
acquiring image data obtained by imaging an object having a surface on which an illumination image is generated;
calculating a variation amount of an edge position of the illumination image and a variation amount of an edge luminance of the illumination image based on the image data; and
evaluating a state of the surface of the object based on the variation amount of the edge position and the variation amount of the edge luminance.
